(19) United States
(12) Patent Application Publication
(10) Pub. No.: US 2003/0129974 A1
(43) Pub. Date: Jul. 10, 2003

(54) Method for providing network service for a mobile teleterminal element

(76) Inventor: Erkki Viitala, Espoo (FI)

Correspondence Address: BIRCH STEWART KOLASCH & BIRCH, PO BOX 747, FALLS CHURCH, VA, 22040-0747, US

(21) Appl. No.: 10/343,738

(22) PCT Filed: Aug. 3, 2001
(86) PCT No.: PCT/FI01/00693

(30) Foreign Application Priority Data
Aug. 3, 2000 (FI) 20001745

(51) Int. Cl. H04M 3/42; H04M 11/00

(52) U.S. Cl. 455/414; 455/406

(57) ABSTRACT

The invention relates to a method for providing network service for a mobile teleterminal element (10). In the method, signalling between the mobile teleterminal element (10) and a mobile network is used to form (101-102) a network service agreement with the mobile network for the mobile teleterminal element. A message defined, or messages defined by the operator of the mobile network, such as a data network page, or data network pages, is, or are sent (103) in the direction of the mobile teleterminal element (10). The mobile network receives a response, or responses from the direction of the mobile telecommunications element (10) and, on the basis of these, interprets a network service agreement as having been concluded for the mobile teleterminal element (10).

The present invention relates to a method, according to the preamble of claim 1, for providing a network service of a mobile network for a mobile teleterminal element. The invention also relates to a method, according to the preamble of claim 19, for means for operating in a telecommunications network.

Methods of this kind are used, to be able to permit the use of a mobile network, to a mobile teleterminal element, such as a mobile station.

According to the state of the art, a mobile station according to a standard can be used in any mobile network at all that supports a corresponding standard, in which case the mobile station can made to operate over a wider geographical area. A mobile station being used outside of its home network can be provided with a network service, if the subscription card of the mobile station has been changed. A mobile station being used outside of its home network can also be provided with a network service, if a roaming agreement has been made between the operators of the home network and the local network. In that case, the home network operator bills the mobile subscription for the use of the local network. The operator of the local network in turn bills the home network operator with the aid of billing messages, so-called call tickets, sent in the telecommunications network, targeting the mobile station. When using a mobile station outside its home network, by means of changing the subscription card, the subscription card can be, for example, a so-called ‘scratch card’, which has an attached prepaid right to use the network. When using a temporary subscription card, billing can also be carried out by means of the control of an intelligent network (Hot Billing), and directed to the entity to be billed.

The local network can, as is known, give an address dynamically to a mobile subscription. One such method is disclosed in U.S. Pat. No. 5,708,655. With the aid of the method, the mobile subscription is given a temporary address, in which case the routing associated with the permanent address of the mobile subscription is no longer targeted on the mobile station, allowing the routing of data packets to be planned as desired on the basis of the dynamic address.

A drawback of the state of the art is that a mobile teleterminal element, for the identity of which network service have not been defined to be provided in the control system of a mobile network, cannot be provided with network service according to control information received from the direction of the mobile teleterminal element.

The invention is intended to eliminate the defects of the state of the art disclosed above and for this purpose create an entirely new type of method for providing network service for a mobile teleterminal element.

The invention is based on using signalling between a mobile teleterminal element and a mobile network to form a network service agreement for the mobile telecommunications element with the mobile network. A message or messages defined by the mobile operator, such as an information network page or pages, are sent in the direction of the mobile teleterminal element. The mobile network receives a response or responses from the direction of the mobile teleterminal element, and, on the basis of these, interprets a network service agreement as having been concluded with the mobile telecommunications element.

More specifically, the method, according to the invention, for providing the network service of a mobile network for a mobile teleterminal element, is characterized by what is stated in the characterizing portion of claim 1. The means, according to the invention, for operating in a telecommunications network is, in turn, characterized by what is stated in the characterizing portion of claim 19.

With the aid of the invention, a mobile teleterminal element, for the identity of which network service has not been defined to be provided in the control system of a mobile network, can be provided with network service according to control information received from the direction of the mobile teleterminal element.

The preferred application environment for the invention is packet-switched mobile networks, such as GPRS, EDGE, UMTS, and wireless local area networks providing public service, such as WLAN. The preferred situation for the application of the invention is one in which the teleterminal element is used in a local network, for example, abroad. In that case, the operator of the local network can provide the teleterminal element with network services and bill the possessor of the teleterminal element for them, the equipment of the operator of the home network being thus not required for taking care of the network services and/or billing.

Terminology:

The term mobile station network resource refers to a telecommunications terminal, a distributed system, a computer program, or the entity, to which a telecommunications connection is to be formed over the trunk network of a mobile network.

A teleterminal element is a device, apparatus, program, software, or combination of these, operating on the customer side of the customer interface of the telecommunications network. A teleterminal element can be, for example, a mobile station smart card, such as a subscriber card, a mobile station, a laptop computer software product, or some combination of these.

The term teleterminal element refers to a teleterminal element, which is set to operate by means of a wireless connection to a mobile network. Such a teleterminal element can be, for example, a mobile station. A teleterminal element can also be, for example, a mobile station smart card, such as a subscriber card, a laptop computer, or a computer software product, which is connected to a mobile network through the functionality of a mobile station.

An agreement proposal message is a message transmitted in digital form, which includes a definition of the service or services available or provided, and of the consideration charged for their use.

The term network services refers to a service providing and/or defining the transmission technology requirements for a telecommunications service. The transmission technology requirements are met, if the teleterminal element is defined according to the network service agreement made with the registers of the mobile network, or a related resource, or management system.

The home network of a specific mobile subscription is the mobile network, in some home subscriber register of which the mobile subscription is defined.

A local network is a mobile network, in no home subscriber register of which the mobile subscription is defined.

In the following, the invention is examined with reference to the accompanying drawings.

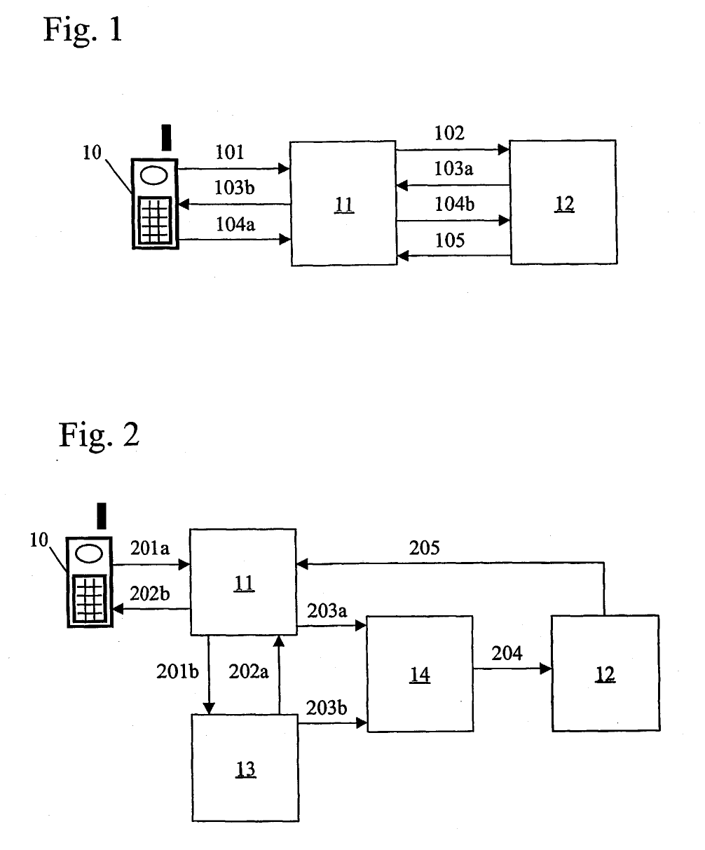

FIG. 1 shows one method according to the invention for setting a mobile network to be ready to provide a network service.

FIG. 2 shows one method according to the invention for monitoring the use of telecommunications services.

In the description of the method shown in FIG. 1, the following numbered elements are used:

The teleterminal element 10 is a mobile teleterminal element, such as a mobile subscription, which is not entered in the home subscription register of the mobile network.

The trunk network 11 of the mobile network is a mobile network trunk network, which includes at least one base station, a subscriber register, and a data packet transmission element.

The subscriber management element 12 is a software and/or apparatus element, forming part of the management system of the mobile network, and which is set to form a network service agreement for a roaming mobile subscription 11 and to set the trunk network of the local network to be available for use by the roaming mobile subscription 10.

In the description of the method shown in FIG. 2, the following numbered elements are used:

The mobile network resource 13 is a mobile network resource, which is available for use by a roaming mobile subscription 11, through the trunk network of the local network.

The mediator 14 is an apparatus and/or software, which is set to control and monitor additional services carried out in the mobile network, such as monitoring the billing message in the direction of the subscriber management element 12, corresponding to the operating data messages and operating message coming from the direction of the mobile network resource 13 and/or the subscriber management element 12.

In the method shown in FIG. 1 for setting the mobile network to be ready to provide a network service, the following stages are carried out. Stage 101 of the method is carried out, in order to determine whether there are grounds for sending a network service agreement proposal in the direction of the teleterminal element 10:

101) The teleterminal element 10 is connected to a trunk network 11 of the mobile network over a signalling connection and the subscriber register is examined to determine whether the teleterminal element 10 has a network service agreement with the mobile network.

The following stages (102-105) of the method are carried out in response to a specific kind of subscriber register entry concerning the teleterminal element 10, or in response to the fact that the subscriber register lacks an entry concerning the teleterminal element 10. Stages 102-103 are carried out, for the user of the teleterminal element 10 to be able to read, from their mobile station, the agreement proposal message of the operator of the local network. Stages 104-105 are carried out in order to provide the network services desired by the user of the teleterminal element 10.

102) A message, which is set to respond to the lack of a subscriber register entry concerning the teleterminal element 10, or a certain kind of subscriber register entry concerning the teleterminal element 10, is sent from the trunk network 11 of the mobile network in the direction of the subscriber management element.

103) An agreement proposal message, such as a Web page containing a proposal for a network service agreement, is sent (103a-103b), under the control of a subscriber management element 12, through the trunk network 11 of the mobile network, in the direction of the teleterminal element 10. The agreement proposal message can state, for example, the acceptable methods of payment, the services and service packets available, the grounds for charging and the price information, and the other terms and conditions of the agreement.

104) A message, which is set to signify acceptance of a network service agreement with a specific content, is received (104a-104b) through the trunk network 11 of the mobile network, by means of the subscriber management element 12, from the direction of the teleterminal element 10.

105) The subscriber management element 12 is used to instruct the trunk network 11 of the mobile network to make a subscriber register entry, corresponding to the accepted network service agreement, in the subscriber register of the trunk network 11 of the mobile network.

In the method shown in FIG. 2, the following stages are carried out to monitor the use of the telecommunications services.

Method stage 201 is carried out, because it is wished to provide the teleterminal element 10 with the possibility to use telecommunications services through the trunk network 11 of the mobile network.

201) The teleterminal element 10 is registered in the subscriber register of the trunk network 11 of the mobile network, according to the network service agreement with a specific content, and a connection creation request, which concerns some element of the trunk network 11 of the mobile network, or a mobile network resource 13, is received (201a) from the direction of the teleterminal element 10.

The registration described above contains the identifier of the teleterminal element 10 and the settings required by the network service agreement with a specific content, such as the identifiers of the services according to the network service agreement. The registration can also contain an amount of the network service available to the teleterminal element 10, such as the amount of money paid, the duration of the roaming time, or the number of times of use.

Stages 202-203 are carried out to provide the services according to the network service agreement that has been made and to monitor the use of these services.

202) A data communications connection between the teleterminal element 10 and an element of the trunk network 11 of the mobile network, or between the teleterminal element 10 and a mobile network resource 13, is formed through the trunk network 11 of the mobile network.

203) User data, such as CDR (Call Detail Record) call tickets, concerning the services used by the teleterminal element 10, are received by means of a mediator 14 from the direction of the trunk network 11 of the mobile network and/or of the mobile network resource 13, and at least one billing message is formed from them.

Stages 204-205 are carried out to target the billing according to the user data on the teleterminal element 10 and to keep the use of network services permitted to the teleterminal element 10 within the limits defined by the network service agreement that has been concluded.

204) At least one billing message is sent from the mediator 14 in the direction of the subscriber management element 12.

205) The functionality of the subscriber management element 12 is used to reduce the amount of the network service available to the teleterminal element 10 on the basis of the billing messages received, and at least one message, which limits the rights of use given to the teleterminal element 10, is sent from the subscriber management element 12 in the direction of the trunk network 11 of the mobile network. The rights of use defined for the teleterminal element 10 in the subscriber register are limited, or the teleterminal element 10 is removed from the subscriber register, in response to at least one message, limiting the rights of use, received in the trunk network of the mobile network.

Embodiments of the invention, differing from those disclosed above, can also be contemplated within the scope of the invention. A new agreement proposal message can be sent from the subscriber management element 12 in the direction of the teleterminal element 10, before the rights of use defined for the teleterminal element 10 are limited in the subscriber register, or the teleterminal element 10 is removed from the subscriber register. If, after this, a message is received from the direction of the teleterminal element 10, which is set to signify acceptance of the network service agreement with a specific content, the subscriber register and the subscriber management element 12 are set to a state corresponding to the network service agreement.

In addition to the roaming teleterminal element 10 being registered in a subscriber register, such as the home subscriber register, of the local network, the services to be provided for the teleterminal element 10, according to the network service agreement, can also be defined in some other system of the operator of the mobile network, such as the subscriber management element 12. This entry can also contain the amount, such as the amount of cash paid or the duration of the roaming time, of the network service available to the teleterminal element 10.

The method according to the invention can also be applied to a teleterminal element, which is defined in a subscriber register of the trunk network 11 of the mobile network. A new kind of network service agreement can be provided for such a mobile subscription.

The method of payment for the network service can be defined in the agreement terms and conditions. In that case, the method of payment can be defined as, for example, a bill or a credit card.

The operations of the subscriber management element 12 and the mediator 14 can also be carried out, differing from the example described, by means of a single device, a distributed system, a computer program, or computer software.

In certain cases of use, the method according to the invention can be used to facilitate payment transfer. The principal purpose of the invention is to send an agreement proposal message and to conclude a telecommunications service agreement concerning at least network services. A teleterminal element utilizing the method according to the invention need not have an active currently valid network service agreement, in order to participate in the conclusion of a telecommunications service agreement according to the invention. In addition, the teleterminal element can also be offered additional services according to the agreement, which do not normally belong to it. The conclusion of a telecommunications service agreement according to the invention does not necessarily require joint operation with the home network of the teleterminal element, or the operator of the home network. The term tele-service, or telecommunications service refers to a service that a service provider provides, in order to satisfy some information and/or telecommunications requirement of its customers. For example, services of a telematic nature, available through a mobile network, are tele-services. These can be produced and/or transmitted in the direction of the teleterminal element, for example, as additional services, in which case the agreement proposal message can include a definition of at least one additional service.

In the method according to the invention, an agreement proposal message is sent in the direction of the teleterminal element at the initiative of the mobile network or a resource behind it. It can contain a proposal for the provision of application services, which provide a network service and possible additional services to the accepting teleterminal element. In the case of the additional services, the mobile network can be set in the role of the intermediary of the services and possibly also of the payment. In the method according to the invention, an agreement can be made on the consideration, or the service can be provided for the teleterminal element without a direct consideration. The consideration can be set to be something other than a cash consideration, for example, the reading of a specific page or specific pages, or the viewing of images, in which case the billing of the teleterminal element is not always essential, when implementing the method according to the invention. The teleterminal element can, however, also be billed according to the telecommunications service agreement and to any possible other agreement concluded in addition to it. Billing can take place, for example, through a network bank or a credit-card system.

Teleterminal elements, which are not customers/subscribers of the mobile network providing the service, are sent an agreement proposal message. The teleterminal elements, to which the agreement proposal message is sent, can be selected, for example, by using a desired criterion to review the selected register/registers, such as a selected VLR (Visitor Location Register), or a related resource or management system, of the mobile network. A sufficient criterion can be that the teleterminal element is connected to the network. It can, however, also concern other definitions relating to the teleterminal element in a register of the mobile network, or a related resource or management system. In order to provide additional services according to the invention, it is also possible to carrying out identification on the basis of the user of the teleterminal element.

As the use of telecommunications networks, such as mobile networks, has become increasingly widespread, a need has arisen to monitor the use of network services, so that the user of a teleterminal element can predict the expenses arising from use. Monitoring is possible with the aid of telecommunication network use limiters. The providers of network or application services can, in turn, use these to prevent the overloading of the network or services. The method according to the invention can be used to set use limiters in a telecommunications network and to implement them in a telecommunications network.

The means for operating in a telecommunications network, which impose a use limit implementing the functionality of use limiters, can be located in the subscriber management element of the telecommunications network, or elsewhere in a telecommunications network, such as in a mobile network. With the aid of use limiters, the use of services provided by a mobile network, or a resource connected to it, can be monitored and limited in the cases of individual users and services. By using means according to the invention, operation in a telecommunications network can be effectively controlled from a mobile network, or through it, in order to limit the performance of the available services.

Means according to the invention for operating in a telecommunications network can be exploited, for example, in the following ways:

A use limiter for a desired service can be set either beforehand, prior to the start of the service, or for a service that a user is already using.

A possibility can be set for the teleterminal element or the service provider to limit the period of validity of the use of the service. The period of validity of the use of the service can be limited, for example, to periods of time of a specific length, which can last, for example, from minutes to months. When each period ends, the possibility to use the service can be prevented, or it can be renewed for the following period.

The user of the teleterminal element can be set to have the possibility, if the service provider approves the arrangement, to continue themselves the period of validity of the service, or to start a new period. This takes place by using the teleterminal element to sent a message expressing the matter to means for operating in the telecommunications network. This message can be a message of commitment by the user, such as a prepayment, a direct debiting agreement, billing permission, or some other message confirming that the service provider will receive a payment for the service.

A limitation of the amount of use of the service can be linked to the telecommunications service agreement concluded according to the invention. The limitation can be expressed, for example, as money, time, or a number of times. According to the amount of use thus approved, it is possible to set an initial balance depicting the initial situation.

The data on the amount of use of the service contained in the billing message sent to the subscriber management element is used to reduce the amount of use available for the service, i.e. the use balance.

A use limiter, which can operate, for instance, in the subscriber management element, can be set to receive a billing message, which states at least the following items: the identifier of the user or the teleterminal element, the identifier of the service to be monitored by the use limiter, the amount of use of the service, such as money, time, or some other unit, the period of use of the service, such as the starting time, the ending time, and the use-balance alarm limit.

If one or several alarm limits are set for the use balance, which are reached before the end of the use balance, a message stating that the alarm limit relating to the use balance has been reached can be sent in the direction of the teleterminal element. A proposal for an increase in the use balance can be attached to the message, so that the use of the service is not suddenly prevented. The user can accept or reject the proposal for increasing the use balance.

Once the entire use balance has been used, the availability of the service to the teleterminal element is removed entirely or in part. After this, a new agreement proposal message can be sent in the direction of the teleterminal element for acceptance or rejection. An increase in the use balance of the use limiter can take place once acceptance has been received from the direction of the teleterminal element. Alternatively, the service provider itself can increase the use balance.

The use limiter may also incorporate functionality for monitoring the losses arises from a campaign that has been implemented, or from some other reason. In a situation in which the amount of use indicated by a billing message exceeds the remains use balance, a loss is incurred by the service provider. The loss is added to a minus balance, which indicates cumulatively, as use time, the accumulated loss of the use limiter in question.

Messages concerning the user limiter can be sent in the direction of the teleterminal element, for example, in the following cases: the creation of the use limiter service, the removal of the use limiter service, alteration of the use balance, or when the alarm limit is reached.

In the present patent application, the terms below refer to the following:

The user is the entity that uses a mobile network or services obtained through it, with the aid of a teleterminal element. The user may be an individual person, a group of people, a company, a group of companies, or someone else who is regarded as being a user. The user may also be a terminal device or data system that operate automatically.

The use limiter is an application for providing an added-value service, in a telecommunications network, such as a mobile network. By setting the use limiter, the user, the operator of the telecommunications network, and/or the service provider can limit and control the use of the service provided. The use limiter can be user and/or service-specific. The user may have one or several use limiters. The use limiter can set to operate, for example, generally in a mobile network, in the subscriber management element of a mobile network, or is some other subscriber management element of a telecommunications network.

The initial balance is a limit, which can be linked to the use limiter. It states the amount of use available at the commencement of the use agreement. The amount of use can be expressed, for example, as money, time, a period of time, or as a number.

The use balance states the amount of use available, relating to the use limiter, at a specific moment. The amount of use can be expressed, for example, as money, time, a period of time, or a number.

The alarm limit is a limit that can be linked user or service-specifically to the user limiter. It can be defined service or user-specifically. In response to reaching the alarm limit, a message can be sent from the use limiter in the direction of the teleterminal element, and/or the teleterminal element's right to use the telecommunications network can be limited.

1. A method for providing the network service of a mobile network for a mobile teleterminal element,
characterized in that
an agreement proposal message, which contains a proposal for a network service agreement, is sent (103) from the mobile network in the direction of the teleterminal element (10),
a message, which is set to signify acceptance of the network service agreement with a specific content, is received (104) from the direction of the teleterminal element (10), and
the mobile network is set (105) to provide the teleterminal element (10) with the services according to the received network service agreement.

2. A method according to claim 1, characterized in that
the identity of the teleterminal element (10) is received (102) from the direction of the teleterminal element (10),
a check is made (102), as to whether the identity of the teleterminal element (10) is defined in a subscriber register of the mobile network, such as in some home subscriber register in the mobile network, and
an agreement proposal message is sent (103) in the direction of the teleterminal element (10), in response to a specific kind of subscriber register entry in the management system of the mobile network.

3. A method according to claim 1 or 2, characterized in that
the identity of the teleterminal element (10) is received (101) from the direction of the teleterminal element (10),
a check is made (101), as to whether the identity of the teleterminal element (10) is defined in a subscriber register of the mobile network, such as a home subscriber register, and
an agreement proposal message is sent (103) in the direction of the teleterminal element (10), in response to the lack of a subscriber register entry concerning the teleterminal element (10) in the management system of the mobile network.

4. A method according to any of claims 1-3, characterized in that the agreement proposal message is sent (103) by means of a Web page, or a corresponding type of mobile application.

5. A method according to any of claims 1-4, characterized in that the acceptable methods of payment, services available, service packets, billing grounds, and/or price information are transmitted (103) in the agreement proposal message.

6. A method according to any of claims 1-5, characterized in that the teleterminal element (10) is registered (201) in the management system (104) of the mobile system, according to the network service agreement with a specific content.

7. A method according to claim 6, characterized in that the entry includes the identifier of the teleterminal element (10) and the settings required by the network service agreement with a specific content, such as the identifiers of the services according to the network service agreement and the amount of the network service available, for example, the amount of money paid and/or the connection time.

8. A method according to any of claims 1-7, characterized in that
a data communications connection is formed (202) through the trunk network (11) of the mobile network, between the teleterminal element (10) and an element of the trunk network (11) of the mobile network, or between the teleterminal element (10) and a mobile network resource (13), and
use information, such as CDR (Call Detail Record) call tickets, on the services used by the teleterminal element (10), is received (203) by means of a mediator (14) from the direction of the trunk network (11) of the mobile network and/or of the mobile network resource,
at least one billing message is formed from the received use information, and
the billing message formed is sent in the direction of the subscriber management element (12).

9. A method according to any of claims 1-8, characterized in that
at least one billing message is sent (204) by means of a mediator (14) in the direction of the subscriber management element (12),
the amount of the tele-service available to the teleterminal element is reduced (205) by means of the functionality of the subscriber management element (12), on the basis of the received billing messages, and
at least one message limiting the right to use the mobile network or the mobile network resource, targeting the teleterminal element (10), is sent from the subscriber management element (12) in the direction of the trunk network (11) of the mobile network.

10. A method according to any of claims 1-9, characterized in that
at least one message limiting the rights of use to the teleterminal element (10) is received from the direction of the subscriber management element (12) in the trunk network (11) of the mobile network, and
in response to the received message limiting the rights of use, the rights of use defined for the teleterminal element (10) in the subscriber register or elsewhere in the management system of the mobile network, are limited to the teleterminal element (10).

11. A method according to any of claims 1-10, characterized in that an agreement proposal message is sent in the direction of the teleterminal element (10), at the initiative of the mobile network, or of a resource behind it.

12. A method according to claim 11, characterized in that a network service agreement is concluded, without the joint operation of the home network of the teleterminal element (10) or of the operator of the home network in question.

13. A method according to any of claims 1-12, characterized in that at least one additional service is produced for the teleterminal element (10) and/or at least one additional service is transmitted in the direction of the teleterminal element (10).

14. A method according to claim 13, characterized in that
the agreement proposal message includes a defined additional service, and
the additional service is produced and/or transmitted according to the agreement proposal message.

15. A method according to any of claims 1-14, characterized in that at least one teleterminal element (10) is selected, to which the agreement proposal message is sent, from a register of the mobile network or a resource or management system linked to it, using a desired criterion or desired criteria, in which case at least one desired criterion is a definition attached to the teleterminal element in a register of the mobile network or of a resource or management system linked to it.

16. A method according to claim 15, characterized in that the desired criterion or desired criteria include the fact that the teleterminal element (10) is connected to a telecommunications network.

17. A method according to any of claims 1-16, characterized in that identification is carried out on the basis of the user of the teleterminal element (10), in order to provide at least one additional service.

18. A method according to any of claims 1-17, characterized in that an agreement on a desired consideration is included in the agreement proposal message and the related reply message, in which case a network or additional service is provided for the teleterminal element, a cash consideration, a functional consideration, such as performing a specified operation or specified operations, reading a specific page or specific pages, or viewing images, is agreed for the service, in which case the billing of the teleterminal element (10) is not essential when carrying out the method according to the invention.

19. Means for operating in a telecommunications network, characterized in that they are set to perform any method according to claims 1-18.
